(19) United States
(12) Patent Application Publication
(10) Pub. No.: US 2019/0107889 A1
(43) Pub. Date: Apr. 11, 2019

(54) INPUT DEVICE

(71) Applicant: Sharp Kabushiki Kaisha, Osaka (JP)

(72) Inventor: Yasuyuki TOGASHI, Sakai City (JP)

(21) Appl. No.: 16/143,511

(22) Filed: Sep. 27, 2018

(30) Foreign Application Priority Data
Oct. 10, 2017 (JP) 2017-196858

(51) Int. Cl. G06F 3/01; G06F 3/0354; G06F 3/0488; B60K 37/04

(52) U.S. Cl. CPC G06F 3/016; G06F 3/03547; B60K 2350/1028; B60K 37/04; G06F 3/0488

(57) ABSTRACT

An input device includes an actuator, an input member, a contact member, and a guide part. The actuator is configured to oscillate. The input member is configured to vibrate as the actuator oscillates. The input member includes an input surface that receives pressing operation. A part of the input surface is disposed to intersect with a vibrating direction in which the input member vibrates as the actuator oscillates. The contact member contacts the input member. The guide part is included in at least one of the input member and the contact member and configured to guide the input member in a direction parallel to the input surface during vibration of the input member.

### CROSS REFERENCE TO RELATED APPLICATION

This application claims priority from Japanese Patent Application No. 2017-196858 filed on Oct. 10, 2017. The entire contents of the priority application are incorporated herein by reference.

### TECHNICAL FIELD

The technology described herein relates to an input device.

### BACKGROUND

One known example of conventional input devices with a touch screen is disclosed in Japanese Unexamined Patent Application Publication No. 2005-222551. The input device according to Japanese Unexamined Patent Application Publication No. 2005-222551 includes a touch screen for inputting a command by touching an operation surface or pressing the operation surface, an actuator for moving the touch screen to at least one direction with respect to a reference body, and a substantially U-shaped spring mechanically coupling the reference body and the touch screen.

The input device according to Japanese Unexamined Patent Application Publication No. 2005-222551 is configured such that the touch screen moves substantially parallel to the operation surface by using the actuator and that the U-shaped spring is elastically deformed parallel to the operation surface. Therefore, in a case in which, for example, the touch screen is bent in a curved shape, it may occur that the vibration of the touch screen that is generated as the actuator oscillates does not transmit to the user properly, and in this case, a sufficient level of the tactile feedback performance is not obtained.

### SUMMARY

The technology described herein was made in view of the above circumstances. An object is to improve performance of the tactile feedback.

An input device according to the technology described herein includes an actuator, an input member, a contact member, and a guide part. The actuator is configured to oscillate. The input member is configured to vibrate as the actuator oscillates. The input member includes an input surface that receives pressing operation. A part of the input surface is disposed to intersect with a vibrating direction in which the input member vibrates as the actuator oscillates. The contact member contacts the input member. The guide part is included in at least one of the input member and the contact member and configured to guide the input member in a direction parallel to the input surface during vibration of the input member.

In this structure, when the actuator oscillates as the pressing operation is performed on the input surface of the input member, the input member vibrates. The vibrating direction intersects with at least a part of the input surface of the input member. On the other hand, the guide part that is included in at least one of the input member and the contact member that contact each other guides the input member in the direction parallel to the input surface during the vibration. Therefore, the vibration in a direction parallel to the input surface is transmitted to an input body with which the pressing operation is performed on the input surface. Thus, the input body can more easily sense feedback, for instance, feedback that indicates pressing the input surface. Although at least a part of the input surface is disposed to intersect with the vibrating direction, the tactile feedback can be properly performed.

According to the technology described herein, performance of the tactile feedback improves.

### BRIEF DESCRIPTION OF THE DRAWINGS

FIG. 1 is a perspective view of an input device according to a first embodiment of the technology described herein.

FIG. 2 is an exploded perspective view of the input device.

FIG. 3 is a plan view of the input device.

FIG. 4 is a side view of the input device.

FIG. 5 is a front view of the input device.

FIG. 6 is a plan view of a base member in the input device.

FIG. 7 is an exploded perspective view of a pressure sensor unit in the input device.

FIG. 8 is a perspective view in which an elastic member and its vicinity in the input device are magnified.

FIG. 9 is a side cross-sectional view of an actuator in the input device.

FIG. 10 is a side cross-sectional view of the pressure sensor unit in the input device.

FIG. 11 is a perspective view of an input device according to a second embodiment of the technology described herein.

FIG. 12 is an exploded perspective view of the input device.

FIG. 13 is a side cross-sectional view of the actuator in the input device.

FIG. 14 is a side cross-sectional view of the pressure sensor unit in the input device.

FIG. 15 is a perspective view of an input device according to a third embodiment of the technology described herein.

FIG. 16 is an exploded perspective view of the input device.

FIG. 17 is a side view of the input device.

FIG. 18 is a front view of the input device.

FIG. 19 is a side view in which an actuator, and a contact member and its vicinity in the input device are magnified.

### DETAILED DESCRIPTION

### First Embodiment

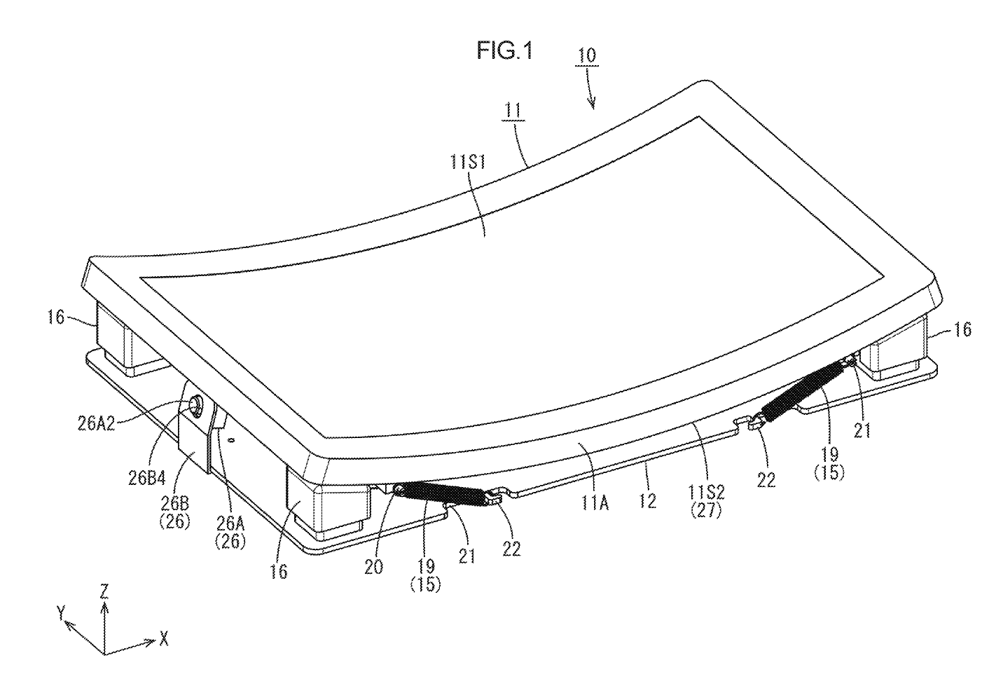

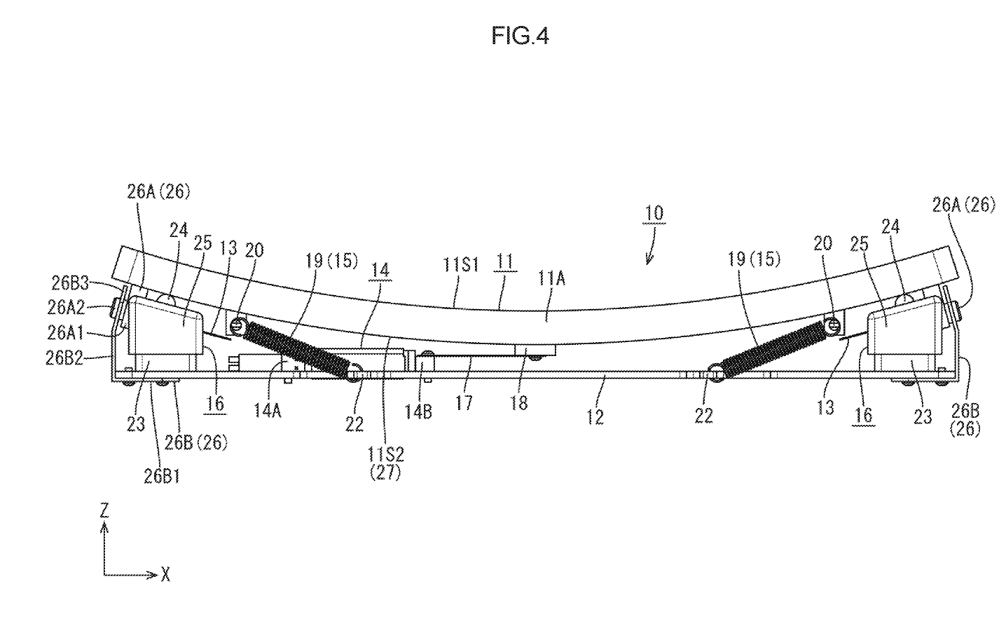

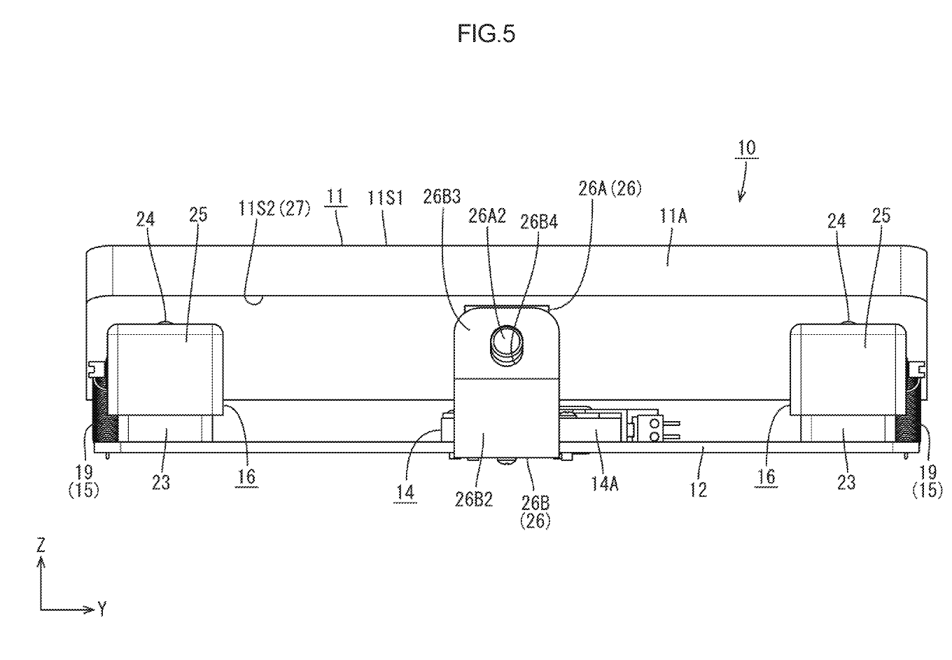

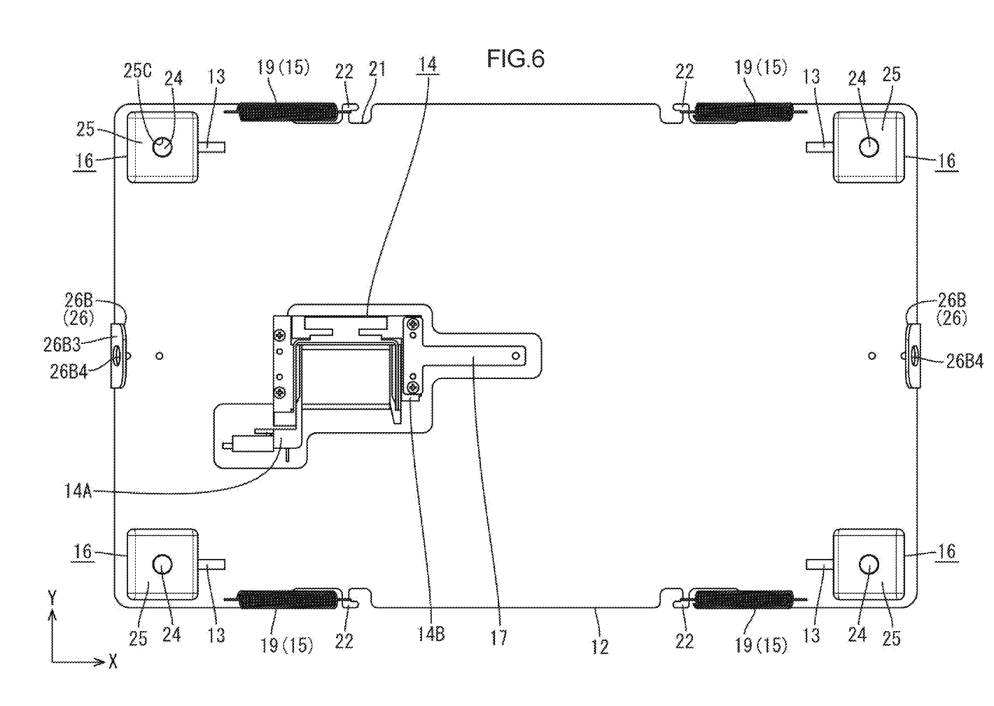

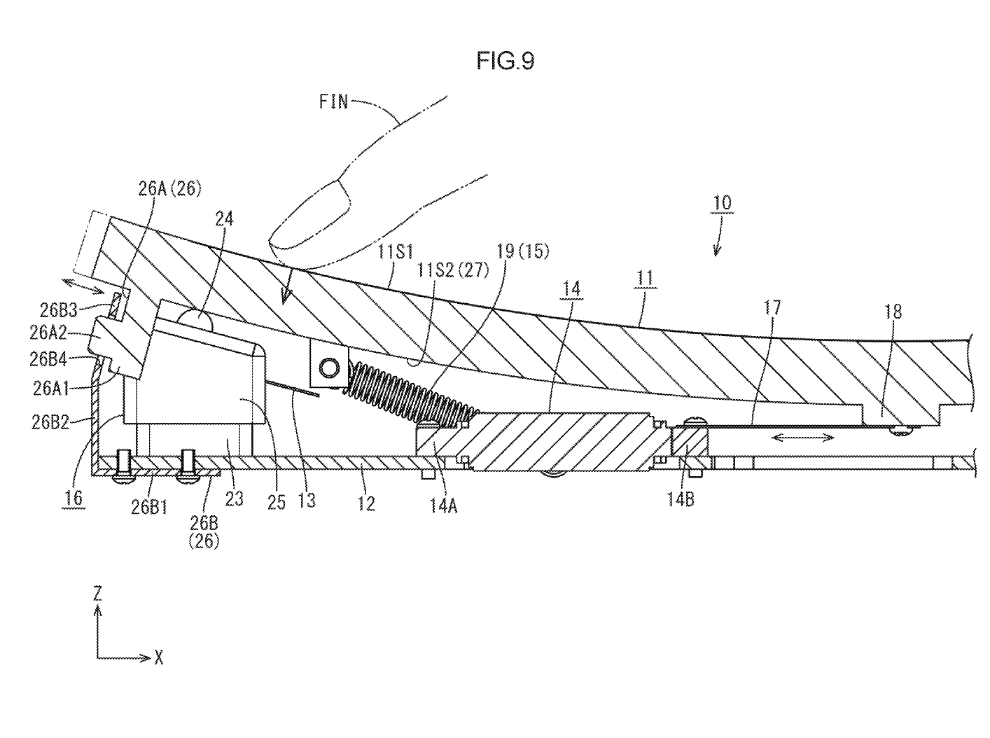

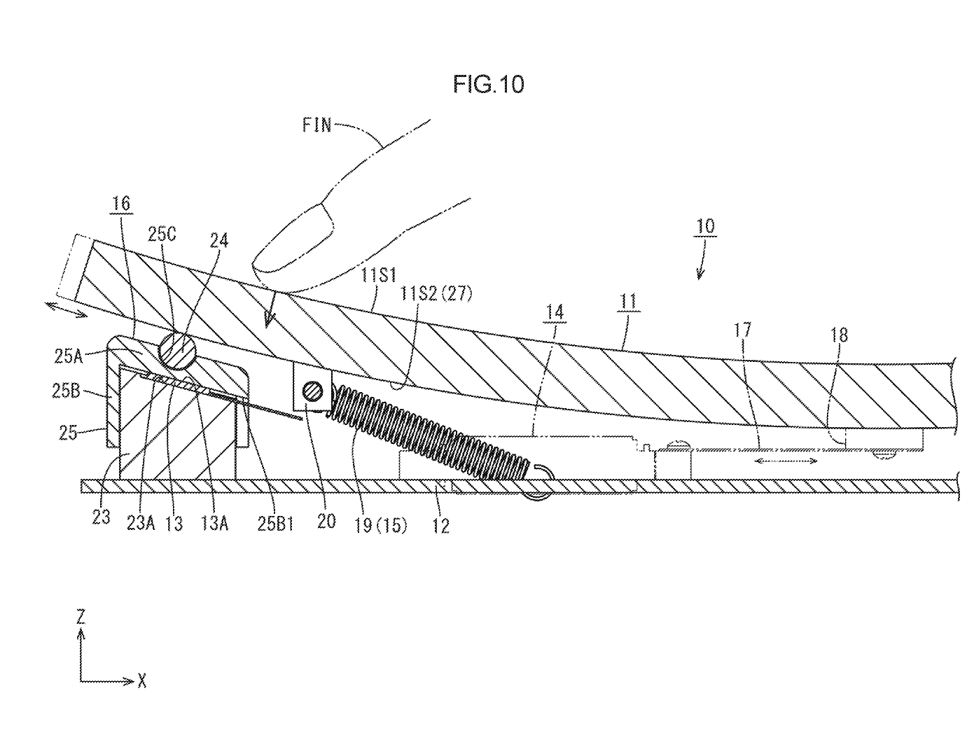

A first embodiment of the technology described herein will be described with reference to FIG. 1 to FIG. 10. In the present embodiment, an input device 10 having a tactile feedback function (tactile sense feedback function) will be described. Note that X-axis, Y-axis, and Z-axis are shown in a part of each drawing, and each axial direction coincides with the direction shown in each drawing. In addition, up-down directions are based on directions in FIG. 4, FIG. 5, FIG. 9, and FIG. 10, and an upper side in each drawing corresponds to a front side, and a lower side in each drawing corresponds to a back side.

As illustrated in FIG. 1, the input device 10 includes at least a liquid crystal display device (input member) 11 that displays an image and to which a pressing operation by a user is input, and a base member 12 to which the liquid crystal display device 11 is attached. The liquid crystal display device 11 has a display function of displaying an image and a touch panel function (position input function) of detecting an input position (touch position, press position) by the user. Although the input device 10 is used for a car navigation system mounted in a vehicle in the present embodiment, the input device 10 can also be used for other purposes.

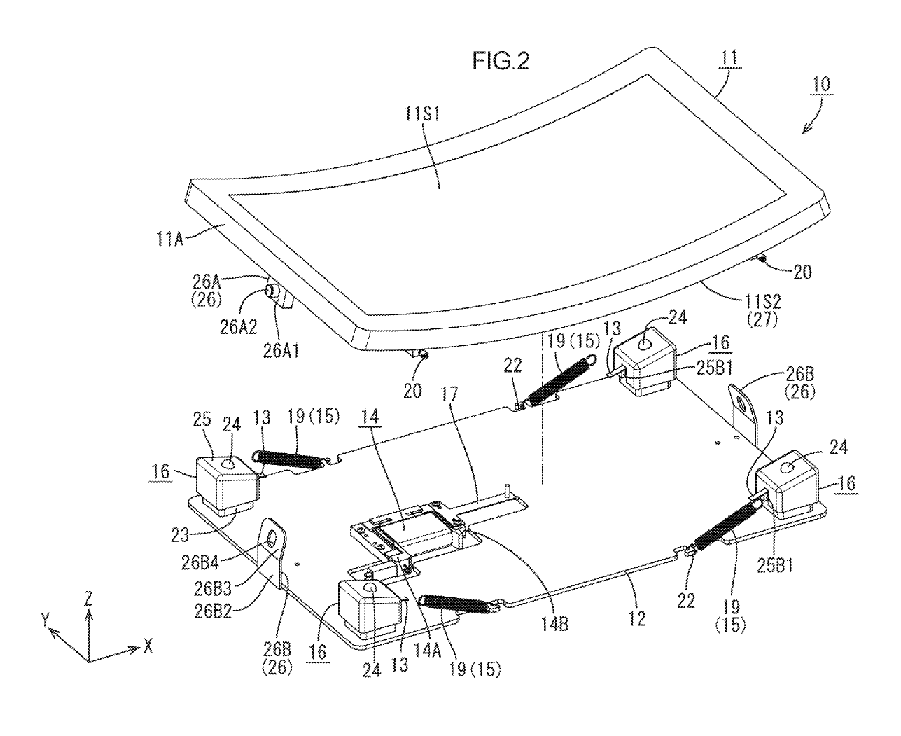

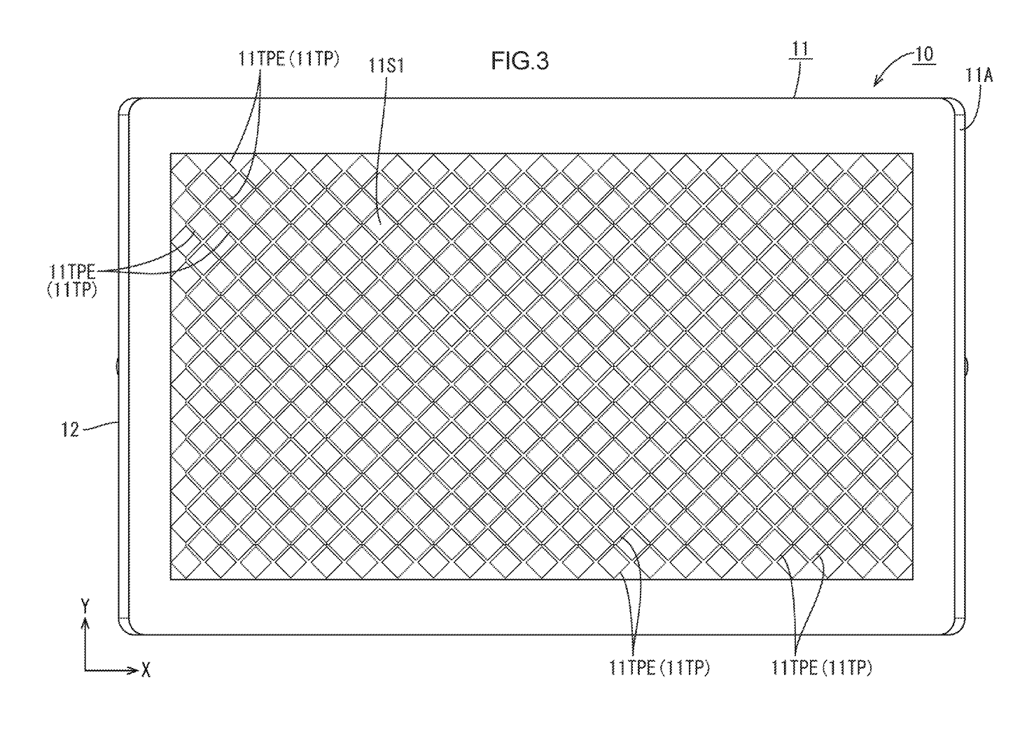

As illustrated in FIG. 2 and FIG. 3, a planar shape of the liquid crystal display device 11 is horizontal rectangle. A long-side direction of the rectangle coincides with an X-axis direction, and a short-side direction thereof coincides with a Y-axis direction, in each drawing. The liquid crystal display device 11 is curved in a substantial arc shape (C-letter shape) such that a central part of the liquid crystal display device 11 in the long-side direction (X-axis direction) recedes to the back side, and both ends thereof in the long-side direction protrude to the front side (inside curve, downward warpage). It can be said that the liquid crystal display device 11 is curved around a curving axis (not shown) that extends in the short-side direction (Y-axis direction) and is disposed on the front side with respect to the liquid crystal display device 11. Therefore, the curving direction of the liquid crystal display device 11 (the direction in which the curvature of an input surface 11S1 and the like to be described below changes) coincides with the long-side direction.

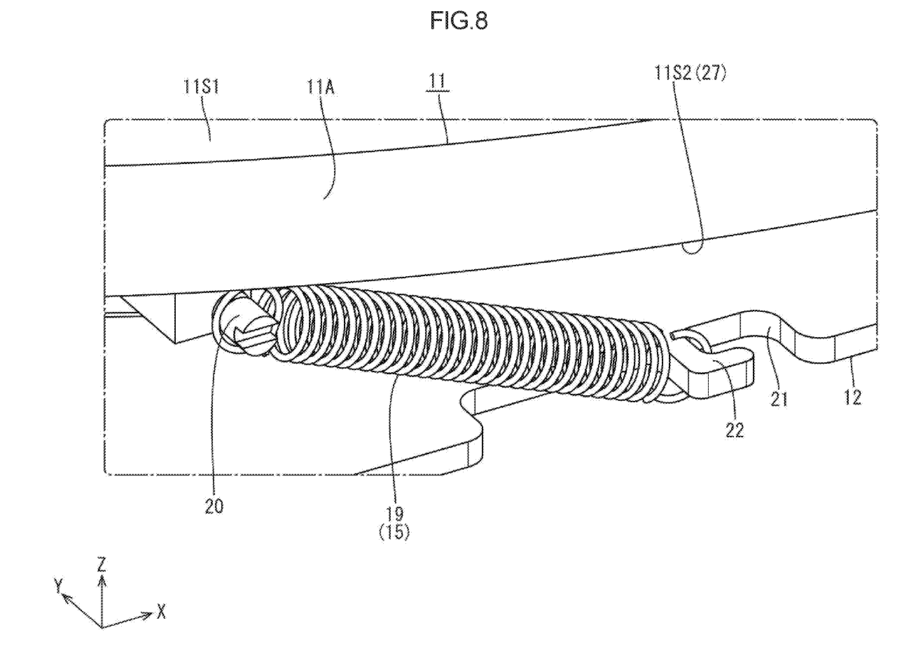

The liquid crystal display device 11 includes a housing 11A as illustrated in FIG. 2. This housing 11A houses a liquid crystal panel (display panel), a backlight device, a cover panel, and the like that are not shown. The liquid crystal panel has a known structure in which a liquid crystal layer is held between a pair of substrates. The backlight device is disposed on the back side with respect to the liquid crystal panel (the side opposite to an input side of the touch operation) and delivers light to be used for the display of the liquid crystal panel. The cover panel is disposed to overlap with the front side of the liquid crystal panel, and includes the input surface 11S1 in which a pressing operation by a user's finger (input body) FIN is performed (see FIG. 8 and FIG. 9 for the finger FIN). The input surface 11S1 is a curved surface that is curved in a substantial arc shape around the curving axis described above, and the position in the Z-axis direction changes in accordance with the position with respect to the curving direction. A back surface of the housing 11A is an input opposite surface (guide part) 11S2 that is disposed on the side opposite to the input surface 11S1 and faces the base member 12 with a space. The input opposite surface 11S2 is curved parallel to the input surface 11S1. Specifically, at the central position in the Y-axis direction, the input surface 11S1 and the input opposite surface 11S2 are at the lowest position in the Z-axis direction and closest to the base member 12. However, at both end positions in the Y-axis direction, the input surface 11S1 and the input opposite surface 11S2 are at the highest position in the Z-axis direction and curved to be farthest from the base member 12. Therefore, the space between the input opposite surface 11S2 and the base member 12 becomes narrower toward the central side in the X-axis direction and larger toward the ends in the X-axis direction. The input surface 11S1 coincides with a display surface including a display area in which an image is displayed, and a non-display area that has a frame shape, surrounds the display area, and does not display an image.

The liquid crystal panel that forms the liquid crystal display device 11 incorporates a touch panel pattern (position detection pattern) 11TP for detecting the input position in which the touch operation of the user is performed as illustrated in FIG. 3. The touch panel pattern 11TP is what is called a projected capacitive type, and a detection method thereof is, for example, self-capacitance. The touch panel pattern 11TP includes at least a plurality of touch electrodes (position detection electrodes) 11TPE that is disposed in matrix in the display area. Therefore, the display area substantially coincides with a touch area in which the input position can be detected, and the non-display area substantially coincides with a non-touch area in which the input position cannot be detected. When the user inputs the touch operation with the user's finger FIN based on the observed image in the display area, the electrostatic capacitance is generated between the finger FIN and the touch electrode 11TPE. Thus, the electrostatic capacitance that is detected by the touch electrode 11TPE near the finger FIN changes as the finger FIN approaches, and the electrostatic capacitance becomes different from that of the touch electrode 11TPE far from the finger FIN. The input position can be detected based on the difference. A flexible board has one end connected to a control board (neither the flexible board nor the control board is shown) and the other end connected to the liquid crystal panel.

As illustrated in FIG. 2 and FIG. 3, the base member 12 is formed of a plate material whose planar shape is horizontal rectangle, and is fixed to a base block disposed on a dashboard of a vehicle (neither the base block nor the dashboard is shown). A pair of base blocks is disposed, for example, to overlap with a pair of short sides of the outer peripheral end of the base member 12, and is provided to protrude to the front side from the installation surface of the dashboard. The base member 12 has a planar shape with a dimension slightly larger than that of the liquid crystal display device 11, and a plate surface thereof is provided with holes (screw holes) for attaching various components (such as an elastic member 15 and a pressure sensor unit 16 to be described below). Note that in a case in which the base member 12 can be directly fixed to the dashboard, the base blocks as above are unnecessary.

As illustrated in FIG. 2, at least the following components are attached to the base member 12: a pressure sensor (pressure sensitive sensor) 13; an actuator 14; and the elastic member 15. The pressure sensor 13 detects the pressure acting on the liquid crystal display device 11 as the touch operation is performed. The actuator 14 vibrates the liquid crystal display device 11. The elastic member 15 elastically supports the liquid crystal display device 11 such that the liquid crystal display device 11 is movable relative to the base member 12. Among these components, the pressure sensor 13 is incorporated in the pressure sensor unit 16 that will be described in detail below. Between the base member 12 and the liquid crystal display device 11 supported by the elastic member 15, a predetermined space is formed in the Z-axis direction.

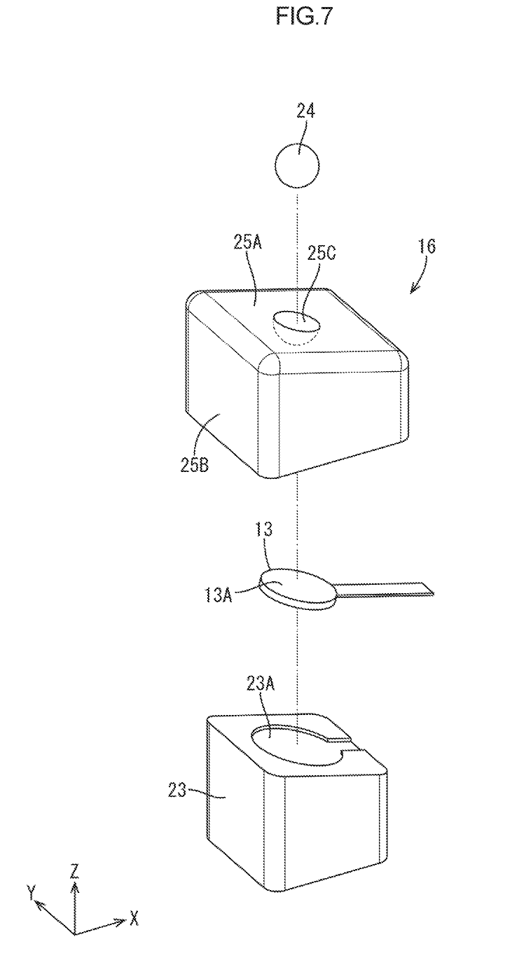

The pressure sensor 13 is what is called a pressure sensitive ink type, and a surface thereof is a pressed surface 13A as illustrated in FIG. 7 and FIG. 10. The pressure sensor 13 includes at least one pair of films formed of an insulating material that is attached to each other, and pressure sensitive electrodes that are on inner surfaces of the films to face each other (neither the films nor the electrodes are shown). The pressure sensor 13 can detect the pressure by using the change of a contact resistance value between pressure sensitive electrodes that face each other in accordance with the pressure that acts in the thickness direction (Z-axis direction) of the pressure sensor 13. The pressure sensitive electrode is formed by printing pressure sensitive ink on a film, for example. The pressure sensor 13 extends in a band-like shape along the X-axis direction. One end of the pressure sensor 13 is incorporated in the pressure sensor unit 16 that is attached to the base member 12 and has a planar shape that is substantially circular. The other end of the pressure sensor 13 is drawn out of the pressure sensor unit 16 and is connected to the control board through a connector (neither the control board nor the connector is shown). The pressure sensor unit 16 will be described in detail below. Four pressure sensors 13 together with four pressure sensor units 16 are disposed near four corners of the liquid crystal display device 11 and the base member 12.

The actuator 14 is what is called an electromagnetic actuator (solenoid actuator) as illustrated in FIG. 2 and FIG. 9. The actuator 14 includes a fixed part 14A that is attached to the base member 12, and a movable part 14B that is attached to the liquid crystal display device 11 to movable relative to the fixed part 14A in the X-axis direction (vibrating direction, oscillating direction). The fixed part 14A at least includes a fixed magnet and a coil that is wound around the fixed magnet (neither are shown), and the movable part 14B at least includes a movable magnet (not shown) that is movable relative to the fixed magnet. As current flows in the coil, a magnetic field is generated in the fixed magnet, and by this magnetic field, the movable magnet of the actuator 14 is sucked. Thus, the movable part 14B can be moved to get close to the fixed part 14A in the X-axis direction. Therefore, the liquid crystal display device 11 to which the movable part 14B is attached can be vibrated in the X-axis direction with respect to the base member 12 to which the fixed part 14A is attached. The fixed part 14A of the actuator 14 is fixed to the base member 12 with a screw member. The movable part 14B of the actuator 14 is fixed to a plate spring member 17 that extends along the X-axis direction with a spring member. The plate spring member 17 includes a flat plate member made of metal (for example, stainless steel), and a plate surface of the plate spring member 17 is parallel to the plate surface of the base member 12. The plate spring member 17 is elastically deformable in the Z-axis direction (pressing direction) corresponding to a normal direction to the plate surface thereof. The plate spring member 17 has one end in the X-axis direction fixed to the movable part 14B with a screw member and the other end in the X-axis direction fixed to a movable side bracket 18 with a block shape that is fixed to the housing 11A of the liquid crystal display device 11 with a screw member. Therefore, the plate spring member 17 is elastically deformable with a cantilever shape using one end side that is fixed to the movable part 14B as a fulcrum, and the other end side is movable relatively in the Z-axis direction as the plate spring member 17 is elastically deformed. At the other end side of the plate spring member 17, the liquid crystal display device 11 is fixed through the movable side bracket 18. Therefore, as the plate spring member 17 is elastically deformed, the liquid crystal display device 11 is movable relative to the plate spring member 17 in the Z-axis direction.

As illustrated in FIG. 2 and FIGS. 4 to 6, the actuator 14 is disposed on the base member 12 at a position inner (closer to the center) of the liquid crystal display device 11 relative to the pressure sensors 13, the pressure sensor units 16, and the elastic members 15, which will be described later. The pressure sensors 13, the pressure sensor units 16, and the elastic members 15 are disposed closer to the four corners of the liquid crystal display device 11. Specifically, in the present embodiment, the actuator 14 is disposed at a central position in the Y-axis direction in the plate surface of the base member 12, and at a position adjacent to the left pressure sensor unit 16 in FIG. 4 on the central side in the X-axis direction. Therefore, it can be said that the actuator 14 is disposed to be surrounded by the four pressure sensors 13 and the four pressure sensor units 16 (elastic members 15) disposed near the four corners of the liquid crystal display device 11. The actuator 14 is disposed with respect to the X-axis direction such that the movable side bracket 18 that is fixed to the other end side of the plate spring member 17 is attached to a substantially central position in regard to the X-axis direction in the liquid crystal display device 11. Therefore, the vibration in the X-axis direction that occurs in the movable part 14B as the actuator 14 oscillates transmits to a substantially central position of the input surface 11S1 and the input opposite surface 11S2 in the liquid crystal display device 11 through the plate spring member 17 and the movable side bracket 18.

As illustrated in FIG. 1, the elastic member 15 supports the liquid crystal display device 11 such that the liquid crystal display device 11 comes to a position away from the base member 12 toward the front side in the Z-axis direction. The elastic member 15 includes an extension coil spring 19 as illustrated in FIG. 8. When the extension coil spring 19 is extended from a natural state along an axial line direction, the elastic force (restoring force) is accumulated in the axial direction. The extension coil spring 19 has one end attached to the liquid crystal display device 11 and the other end attached to the base member 12, and the extension coil spring 19 is held in a posture that the axial direction intersects with both the X-axis direction and the Z-axis direction. Thus, the length of the extension coil spring 19 can be secured sufficiently while the installation space of the extension coil spring 19 in the Z-axis direction is maintained small. The extension coil spring 19 can be elastically deformed freely not only in the X-axis direction and the Z-axis direction but also in the directions oblique to the X-axis direction and the Y-axis direction. The extension coil spring 19 always applies, to the liquid crystal display device 11, the extension force toward the base member 12. Therefore, it is possible to always act the pressure on the pressure sensor 13 from the liquid crystal display device 11. This is preferable in eliminating the time lag that could occur after the pressing operation is input to the liquid crystal display device 11 and before the pressure is detected by the pressure sensor 13. In addition, an outer surface of the housing 11A of the liquid crystal display device 11 that extends along the X-axis direction is provided with a first spring attachment part 20 with a hook shape to which one end of the extension coil spring 19 is attached. The base member 12 is provided with a spring insertion opening 21 through which the other end of the extension coil spring 19 is inserted. At an opening edge of the spring insertion opening 21, a second spring attachment part 22 is provided. The second spring attachment part 22 has a hook shape to which the other end of the extension coil spring 19 is attached. As illustrated in FIG. 4, four extension coil springs 19 are disposed at positions adjacent to the four pressure sensor units 16, which are disposed near the four corners of the liquid crystal display device 11, on the central side in regard to the X-axis direction. The four extension coil springs 19 are disposed adjacent to the four pressure sensor units 16 and the liquid crystal display device 11 on the outer side with respect to the Y-axis direction as illustrated in FIG. 5. The four extension coil springs 19 are disposed in a substantially symmetrical shape with respect to the X-axis direction and the Y-axis direction.

The pressure sensor unit 16 will be described. The pressure sensor unit 16 is disposed on a plate surface on the front side of the base member 12 as illustrated in FIG. 2, and is disposed to be held between the liquid crystal display device 11 and the base member 12 with respect to the Z-axis direction. The pressure sensor units 16 are disposed closer to the four corners of the liquid crystal display device 11 and the base member 12 as illustrated in FIG. 4 to FIG. 6. The pressure sensor units 16 are disposed adjacent to four elastic members 15, which will be described later. The pressure sensor units 16 are on the central side of the liquid crystal display device 11 and the base member 12 relative to the elastic members 15 with respect to the Y-axis direction. Furthermore, the pressure sensor units 16 are disposed adjacent to the ends of the liquid crystal display device 11 and the base member 12 with respect to the X-axis direction.

As illustrated in FIGS. 7 and 10, the pressure sensor unit 16 further includes a sensor holder (sensor holding member) 23 that holds the pressure sensor 13, a contact member 24 to be in contact with the liquid crystal display device 11, and a contact member holder 25 that holds the contact member 24. In this manner, disposing the contact member 24 and the pressure sensor 13 in the overlapped manner can eliminate the arrangement space dedicated to the pressure sensor 13 and the arrangement space dedicated to the contact member 24. Thus, the arrangement space can be saved. A planar shape of the sensor holder 23 is a substantially square block-like shape and the sensor holder 23 is fixed to the base member 12 with a screw member in a state in which a back surface thereof contacts the base member 12. A front surface of the sensor holder 23 (surface facing the contact member holder 25) is provided with a depression that corresponds to a sensor housing concave part 23A that houses the pressure sensor 13. The pressure sensor 13 housed in the sensor housing concave part 23A is disposed such that the contact member 24 and the contact member holder 25 are held between the pressure sensor 13 and the liquid crystal display device 11. The front surface of the sensor holder 23 is curved parallel to the input opposite surface 11S2 of the liquid crystal display device 11, and is lower on the central side of the liquid crystal display device 11 and higher on the outer side in the X-axis direction. Along with this, the pressed surface 13A of the pressure sensor 13 housed in the sensor housing concave part 23A is curved parallel to the input opposite surface 11S2 of the liquid crystal display device 11, and is lower on the central side of the liquid crystal display device 11 and higher on the outer side in the X-axis direction.

The contact member 24 includes a sphere corresponding to a rolling element as illustrated in FIG. 7. As illustrated in FIG. 10, the contact member 24 is disposed such that a part thereof (specifically, about a half thereof) protrudes from the front surface of the contact member holder 25, and is in point contact with the input opposite surface 11S2 of the liquid crystal display device 11. The contact member 24 is supported to be capable of rolling along the outer peripheral surface thereof by the contact member holder 25 that will be described next. The contact member holder 25 has a cap-like shape that is put on the sensor holder 23 as a whole as illustrated in FIG. 7 and FIG. 10. The contact member holder 25 includes a main part 25A and a cylindrical part 25B. The main part 25A is disposed between the contact member 24 and the pressure sensor 13 or the sensor holder 23. The cylindrical part 25B protrudes from an outer peripheral end of the main part 25A to the back side. On the front surface of the main part 25A of the contact member holder 25 (the surface facing the liquid crystal display device 11 and the contact member 24), a depression is formed as a contact member housing concave part 25C that houses the contact member 24. An inner surface of the contact member housing concave part 25C forms a substantially semi-spherical shape along the outer peripheral surface of the contact member 24 and is in surface contact with the outer peripheral surface of the contact member 24. Thus, while the contact member 24 maintains its central position at a constant position in the X-axis direction and the Y-axis direction, the contact member 24 is held in a state of being freely rolled around its center. Each of the front surface and the back surface of the main part 25A of the contact member holder 25 is curved parallel to the input opposite surface 11S2 of the liquid crystal display device 11, and is lower toward the central side of the liquid crystal display device 11 and higher toward the outside in the X-axis direction. Thus, between the input opposite surface 11S2 of the liquid crystal display device 11 and the front surface of the main part 25A of the contact member holder 25, a substantially constant space is maintained regardless of the position in the X-axis direction, and the back surface of the main part 25A is in surface contact with the front surface of the pressure sensor 13. The main part 25A of the contact member holder 25 supports the contact member 24 from the back side and presses the pressure sensor 13 from the front side, and is disposed to be held between the contact member 24 and the pressure sensor 13 in the Z-axis direction. The cylindrical part 25B of the contact member holder 25 has a square cylindrical shape, and is disposed to surround the sensor holder 23 from the outer peripheral side. The cylindrical part 25B is provided with a notch 25B1 through which the drawn part of the pressure sensor 13 passes (see FIG. 2).

The liquid crystal display device 11 and the base member include a concavo-convex engagement structure 26 that concavo-convexly engages the liquid crystal display device 11 and the base member 12 with each other as illustrated in FIG. 2 and FIG. 9. The concavo-convex engagement structure 26 includes a liquid crystal display device-side engagement structure 26A included in the liquid crystal display device 11, and a base member-side engagement structure 26B included in the base member 12. The liquid crystal display device-side engagement structure 26A includes a base part 26A1 that protrudes from the input opposite surface 11S2 of the housing 11A to the back side, and an engagement convex part 26A2 that protrudes from near a protruding end of the base part 26A1. The base part 26A1 has a block-like shape and protrudes from near both ends in the X-axis direction on the input opposite surface 11S2 along a normal direction to the input opposite surface 11S2 (second direction), and is oriented the outside of the liquid crystal display device 11 in the X-axis direction. The engagement convex part 26A2 has a cylindrical shape that protrudes from the base part 26A1 to the outside, and the protruding direction is parallel to the input opposite surface 11S2 and obliquely upward as illustrated in FIG. 9. The base member-side engagement structure 26B includes a base attachment part 26B1 to be attached to the base member 12, a rising part 26B2 that rises from the base attachment part 26B1 to the front side, and a base part parallel part 26B3 that further rises from the rising part 26B2 and is parallel to the base part 26A1 of the liquid crystal display device-side engagement structure 26A. The base attachment part 26B1 is attached to the base member 12 with a screw member in a state of being in contact with the back surface of the base member 12. The rising part 26B2 is parallel to the Z-axis direction and substantially perpendicular to a plate surface of the base attachment part 26B1 and the base member 12. The base part parallel part 26B3 is inclined inward with respect to the rising part 26B2, and is disposed with a certain external space from the base part 26A1 parallel to the base part parallel part 26B3 (without contact) in the curving direction of the input opposite surface 11S2 (a first direction, a direction in which the liquid crystal display device 11 is guided by a guide part 27). At a central part of the base part parallel part 26B3, an engagement concave part 26B4 that receives the engagement convex part 26A2 of the liquid crystal display device-side engagement structure 26A is formed to penetrate therethrough. The engagement concave part 26B4 has an oval shape whose length direction (major-axis direction) coincides with the Z-axis direction and whose width direction (minor-axis direction) coincides with the Y-axis direction. The length of the engagement concave part 26B4 is larger than the diameter (outer shape dimension) of the engagement convex part 26A2, and the width of the engagement concave part 26B4 is substantially the same as the diameter of the engagement convex part 26A2. Thus, the engagement convex part 26A2 engaged within the engagement concave part 26B4 is movable relative to the engagement concave part 26B4 in a first direction corresponding to the curving direction of the input opposite surface 11S2 and a second direction corresponding to the normal direction to the input opposite surface 11S2 but not in a third direction (Y-axis direction) that is perpendicular to the first direction and the second direction.

The technology described herein has the aforementioned structure, and operation thereof will be described next. When a user inputs a pressing operation by pressing the input surface 11S1, which is the front surface of the cover panel, with the user' s finger FIN, the pressing force along the normal direction acts on the input surface 11S1 that is curved as illustrated in FIG. 9 and FIG. 10. Note that as typically illustrated in FIG. 9 and FIG. 10, the pressing operation by the finger FIN is input near the end of the input surface 11S1 in the X-axis direction. When the pressing force acts on the input surface 11S1 that is curved, the extension coil spring 19 that is the elastic member 15 attached to the liquid crystal display device 11 and the base member 12 is elastically deformed in the normal direction (second direction) of the input surface 11S1 corresponding to the pressing direction of the pressing operation. Thus, the shift of the liquid crystal display device 11 relative to the base member 12 in the second direction is allowed, and after that, the liquid crystal display device 11 is restored to the position before the pressing operation. When the pressing operation is performed on the liquid crystal display device 11, the liquid crystal display device 11 is movable relative to the base member 12 by the concavo-convex engagement structure 26 in the second direction as illustrated in FIG. 9. Note that when the pressing operation position by the finger FIN is the central position of the input surface 11S1 in the X-axis direction, the pressing direction coincides with the Z-axis direction. Here, in the pressure sensor 13 incorporated in the pressure sensor unit 16 attached to the base member 12, the contact member 24 and the contact member holder 25 are displaced toward the pressure sensor 13 in the second direction as the liquid crystal display device 11 is displaced as illustrated in FIG. 10. Thus, the pressed surface 13A is pressed. In this manner, the pressure that acts on the liquid crystal display device 11 is transmitted to the pressure sensor 13 through the contact member 24 and the contact member holder 25, and is detected. Since the pressed surface 13A of the pressure sensor 13 is disposed parallel to the input surface 11S1, the pressure detection accuracy becomes higher as compared to the case in which the pressed surface 13A is disposed to intersect with the input surface 11S1. On the other hand, in a case in which the user unintentionally touches the cover panel by mistake, the liquid crystal display device 11 is hardly displaced in the second direction; therefore, the pressure sensor 13 does not detect the pressure, or the detected pressure becomes a value not more than a threshold, and thus the input error can be prevented as appropriate. When the pressing operation is input, the touch panel pattern 11TP included in the liquid crystal panel in the liquid crystal display device 11 can detect the input position.

The plate spring member 17 has one end attached to the movable part 14B of the actuator 14 and the other end attached to the liquid crystal display device 11 through the movable side bracket 18. When the liquid crystal display device 11 is displaced relative to the base member 12 so as to approach the base member 12 in the second direction as the pressing operation is input to the liquid crystal display device 11 as above, the other end of the plate spring member 17 is displaced to the back side in the Z-axis direction as illustrated in FIG. 9. Here, the plate spring member 17 is elastically deformed in a cantilever shape in the Z-axis direction using one end side as a fulcrum, and this deformation can relieve the stress on the actuator 14.

In a case in which the pressure detected by the pressure sensor 13 in the pressing operation is more than the threshold, a controller determines that the input of the pressing operation is performed properly and the actuator 14 oscillates in accordance with this determination. The oscillation of the actuator 14 can be controlled as appropriate based on the input position of the pressing operation detected by the touch panel pattern 11TP. As the actuator 14 oscillates, the liquid crystal display device 11 vibrates. Here, the vibrating direction of the actuator 14 coincides with the X-axis direction and intersects with the input surface 11S1 that is curved as illustrated in FIG. 9 and FIG. 10. On the other hand, the input opposite surface 11S2 of the liquid crystal display device 11 with which the contact member 24 is in contact is curved parallel to the input surface 11S1 as illustrated in FIG. 10; therefore, the liquid crystal display device 11 that vibrates as the actuator 14 oscillates can be displaced in the direction parallel to the input surface 11S1 (first direction). Specifically, when the liquid crystal display device 11 is displaced outward in the X-axis direction as the vibration occurs, a component force parallel to the input surface 11S1 acts by the input opposite surface 11S2, and with this component force, the input opposite surface 11S2 runs on the contact member 24 and the liquid crystal display device 11 is displaced in the first direction. Here, since the contact member 24 that is a sphere (rolling element) is freely rolled, the friction resistance that can occur between the contact member 24 and the liquid crystal display device 11 as the contact target is reduced. Thus, the liquid crystal display device 11 is smoothly guided. Note that in FIG. 9 and FIG. 10, the outer shape of the liquid crystal display device 11 that is displaced in the first direction is shown with a two-dot chain line. In this manner, in the present embodiment, the input opposite surface 11S2 forms the guide part 27 that displaces the liquid crystal display device 11 in the first direction. Thus, the vibration in a direction parallel to the input surface 11S1 is transmitted to the finger FIN that has input the pressing operation to the input surface 11S1; therefore, the user feels as if the user pressed a virtual button in the second direction on the input surface 11S1 by a lateral force field phenomenon.

As described above, even when the input surface 11S1 is disposed to intersect with the vibrating direction of the actuator 14, whether the pressing operation is input to the liquid crystal display device 11 can be detected, and when the pressing operation is input, the tactile feedback to the pressing operation can be performed by vibrating the liquid crystal display device 11. In particular, since the friction resistance is reduced by the rolling of the contact member 24, the vibration of the liquid crystal display device 11 attenuates less easily, and therefore, the tactile feedback performance is enhanced. In addition, when the actuator 14 oscillates, the extension coil spring 19 corresponding to the elastic member 15 attached to the liquid crystal display device 11 and the base member 12 is elastically deformed in the first direction corresponding to the direction in which the liquid crystal display device 11 is displaced by the guide part 27 as illustrated in FIG. 9. Thus, the shift of the liquid crystal display device 11 relative to the base member 12 in the X-axis direction is allowed, and then the liquid crystal display device 11 is restored to the position before the pressing operation. When the liquid crystal display device 11 is displaced by the guide part 27 as the actuator 14 oscillates, the liquid crystal display device 11 is allowed to be displaced relative to the base member 12 in the first direction by the concavo-convex engagement structure 26 as illustrated in FIG. 9. In addition, the concavo-convex engagement structure 26 restricts the shift of the liquid crystal display device 11 relative to the base member 12 in the third direction that is perpendicular to both the first direction and the second direction. Therefore, even when the contact member 24 being in contact with the input opposite surface 11S2 of the liquid crystal display device 11 does not have such a restriction function, it is possible to avoid a situation in which the liquid crystal display device 11 is deviated in position relative to the base member 12 in the third direction by the influence of the oscillation of the actuator 14 or the like.

As described above, the input device 10 according to the present embodiment includes: the actuator 14; the liquid crystal display device (input member) 11 that includes the input surface 11S1 in which the pressing operation is input, that is configured to be vibrated by the actuator 14, and that is disposed such that at least a part of the input surface 11S1 intersects with the vibrating direction of the actuator 14; the contact member 24 that contacts the liquid crystal display device 11; and the guide part 27 that is included in at least one of the liquid crystal display device 11 and the contact member 24 and that is configured to displace the liquid crystal display device 11 that vibrates as the actuator 14 oscillates, in the direction parallel to the input surface 1151.

Thus, the liquid crystal display device 11 vibrates when the actuator 14 oscillates as the pressing operation is input to the input surface 11S1 of the liquid crystal display device 11. Here, the vibrating direction of the actuator 14 intersects with at least a part of the input surface 11S1 in the liquid crystal display device 11. On the other hand, the guide part 27 included in at least one of the liquid crystal display device 11 and the contact member 24 that are in contact with each other displaces the liquid crystal display device 11, which vibrates as the actuator 14 oscillates, in a direction parallel to the input surface 11S1. Therefore, the vibration in a direction parallel to the input surface 11S1 is transmitted to the finger (input body) FIN that has input the pressing operation to the input surface 11S1. Thus, the finger FIN easily feels as if the user pressed in the pressing direction. As a result, even when at least a part of the input surface 11S1 is disposed to intersect with the vibrating direction of the actuator 14, the tactile feedback can be performed suitably.

In addition, the pressure sensor 13 that detects the pressure acting on the liquid crystal display device 11 along with the pressing operation is included. Thus, when the pressing operation is input to the liquid crystal display device 11, the pressure that acts on the liquid crystal display device 11 is detected by the pressure sensor 13. When the actuator 14 oscillates based on the pressure detected by the pressure sensor 13, the liquid crystal display device 11 vibrates, and the vibration can be transmitted to the finger FIN that has input the pressing operation.

The pressure sensor 13 is disposed such that at least a part of the contact member 24 is held between the pressure sensor 13 and the liquid crystal display device 11. Thus, when the pressing operation is input to the liquid crystal display device 11, the pressure that acts on the liquid crystal display device 11 is transmitted to the pressure sensor 13 through at least a part of the contact member 24, and is detected. Since the pressure sensor 13 can be disposed by using an arrangement space for the contact member 24, the arrangement space dedicated to the pressure sensor 13 is unnecessary. Thus, the arrangement space can be saved.

In addition, the pressure sensor 13 includes the pressed surface 13A that receives the pressure, and is disposed such that the pressed surface 13A is parallel to the input surface 11S1. Thus, the pressure detection accuracy becomes higher than that in the case in which the pressed surface 13A is disposed to intersect with the input surface 11S1.

Further provided are the base member 12 in which at least the contact member 24 is provided, and the elastic member 15 that is attached to the liquid crystal display device 11 and the base member 12 and is elastically deformable both in the direction in which the liquid crystal display device 11 is displaced by the guide part 27 and in the normal direction to the input surface 11S1. Thus, when the pressing operation is input to the liquid crystal display device 11, the elastic member 15 attached to the liquid crystal display device 11 and to the base member 12 is elastically deformed in the normal direction to the input surface 11S1 in the liquid crystal display device 11. Therefore, after the liquid crystal display device 11 is displaced relative to the base member 12 in the normal direction, the liquid crystal display device 11 is restored to the position before the pressing operation. When the actuator 14 oscillates, the elastic member 15 is elastically deformed in the direction in which the liquid crystal display device 11 is displaced by the guide part 27. Thus, the liquid crystal display device 11 is displaced relative to the base member 12 in the displacing direction and then restored to the position before the pressing operation. Accordingly, the pressure that acts on the liquid crystal display device 11 can be detected by the pressure sensor 13 properly, and the input error can be prevented as appropriate.

The elastic member 15 includes the extension coil spring 19 that has one end attached to the liquid crystal display device 11 and the other end attached to the base member 12. Thus, in a case in which the pressing operation is input to the liquid crystal display device 11, the extension coil spring 19 is elastically deformed in the normal direction to the input surface 11S1, and in a case in which the actuator 14 oscillates, the extension coil spring 19 is elastically deformed in the direction in which the liquid crystal display device 11 is displaced by the guide part 27. In addition, the extension coil spring 19 always applies, to the liquid crystal display device 11, the extension force toward the base member 12; therefore, the pressure from the liquid crystal display device 11 can always act on the pressure sensor 13. This is preferable in eliminating the time lag that could occur after the pressing operation is input to the liquid crystal display device 11 and before the pressure is detected by the pressure sensor 13.

The liquid crystal display device 11 includes the input opposite surface 11S2 that is disposed opposite to the input surface 11S1, is parallel to the input surface 11S1, and forms the guide part 27. The contact member 24 includes a rolling element that contacts the input opposite surface 11S2 and is rollable. Thus, when the liquid crystal display device 11 is displaced by the vibration that is transmitted from the actuator 14, the liquid crystal display device 11 is guided to be displaced in the direction along the input surface 11S1 such that the input opposite surface 11S2 of the liquid crystal display device 11 that is disposed opposite to the input surface 11S1, is parallel to the input surface 11S1, and forms the guide part 27 is brought into contact with the rolling element that is included in the contact member 24. As the liquid crystal display device 11 is displaced, the rolling element is rolled, and this rolling enables the smooth shift of the liquid crystal display device 11 and enhances the tactile feedback performance.

The rolling element is a sphere. When the rolling element is a roller type, a roll shaft is necessary, but when the rolling element is a sphere, such a roll shaft is unnecessary. In addition, when the rolling element is in point contact with the input opposite surface 11S2, the friction resistance between the rolling element and the liquid crystal display device 11 is reduced, and the vibration of the liquid crystal display device 11 attenuates less easily. Thus, the tactile feedback performance is enhanced. In addition, since the flexibility of the rolling direction of the rolling element is increased, the liquid crystal display device 11 is displaced more smoothly.

Furthermore, at least the base member 12 provided with the contact member 24 and the concavo-convex engagement structure 26 that is included in the liquid crystal display device 11 and to the base member 12 to concavo-convexly engage the liquid crystal display device 11 and the base member 12 with each other are provided. The concavo-convex engagement structure 26 allows the shift of the liquid crystal display device 11 relative to the base member 12 in the first direction corresponding to the direction in which the liquid crystal display device 11 is displaced by the guide part 27 and the second direction corresponding to the normal direction to the input surface 11S1; however, the concavo-convex engagement structure 26 restricts the shift of the liquid crystal display device 11 relative to the base member 12 in the third direction that is perpendicular to both the first direction and the second direction. Thus, in the case in which the liquid crystal display device 11 is displaced by the guide part 27 as the actuator 14 oscillates, the concavo-convex engagement structure 26 allows the liquid crystal display device 11 to be displaced relative to the base member 12 in the first direction. When the pressing operation is performed on the liquid crystal display device 11 by the finger FIN, the concavo-convex engagement structure 26 allows the liquid crystal display device 11 to be displaced relative to the base member 12 in the second direction. The concavo-convex engagement structure 26 restricts the shift of the liquid crystal display device 11 relative to the base member 12 in the third direction that is perpendicular to the first direction and the second direction; therefore, even when the rolling element that contacts the input opposite surface 11S2 of the liquid crystal display device 11 does not have such a restricting function, it is possible to avoid a situation in which the liquid crystal display device 11 is deviated in position relative to the base member 12 in the third direction due to the influence of the oscillation of the actuator 14 or the like.

The planar shape of the liquid crystal display device 11 is square, and the contact members 24 are disposed at four corners of the liquid crystal display device 11. The actuators 14 are disposed more inside the liquid crystal display device 11 than the contact members 24 are. Thus, as the actuators 14 disposed more inside the liquid crystal display device 11 than the contact members 24 disposed at the four corners of the liquid crystal display device 11 are oscillated, the entire liquid crystal display device 11 can be vibrated as appropriate. Since the contact members 24 are disposed at the four corners of the liquid crystal display device 11, the shift of the liquid crystal display device 11 can be guided as appropriate.

The liquid crystal display device 11 includes the liquid crystal panel (display panel) including the display surface that displays an image as the input surface 11S1, and the touch panel pattern 11TP that detects the input position of the pressing operation on the display surface. Thus, when the pressing operation is input to the display surface corresponding to the input surface 11S1 based on the image displayed on the display surface of the liquid crystal panel, the input position can be detected by the touch panel pattern 11TP. Based on the input position of the pressing operation detected by the touch panel pattern 11TP, the vibration to be applied to the liquid crystal display device 11 by the actuator 14 can be controlled.

### Second Embodiment

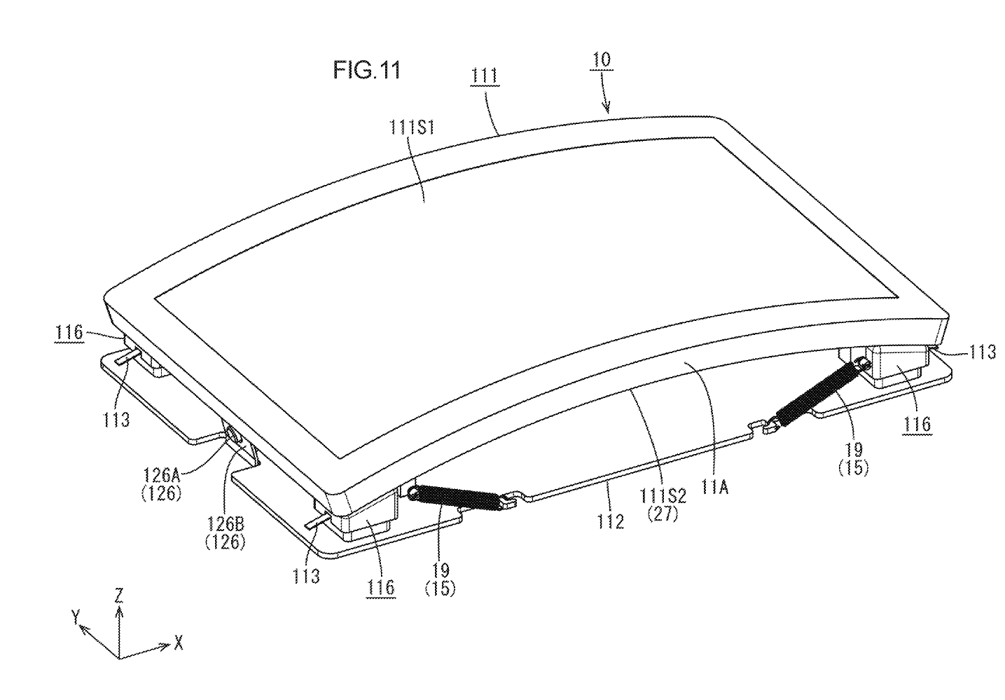

A second embodiment of the technology described herein will be described with reference to FIG. 11 to FIG. 14. In this second embodiment, a curved shape of a liquid crystal display device 111 is different from that in the first embodiment. Note that description of the structure, the operation, and the effect that are similar to those of the first embodiment is not repeated.

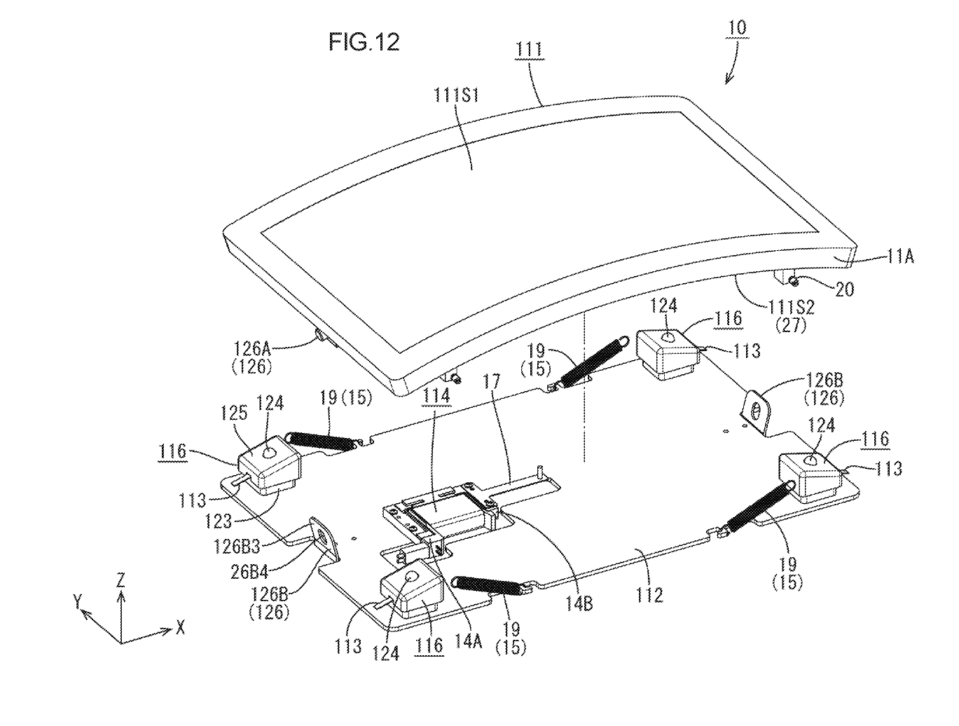

As illustrated in FIG. 11 and FIG. 12, the liquid crystal display device 111 according to the present embodiment is curved in a substantial arc shape (outside curve, upward warpage) in which a central part in the long-side direction protrudes to the front side and both ends in the long-side direction recede to the back side. It can be said that the liquid crystal display device 111 is curved around a curving axis, which is not shown, that extends in a short-side direction and is disposed on the back side with respect to the liquid crystal display device 111. Accordingly, at the central position in the Y-axis direction, an input surface 111S1 and an input opposite surface 111S2 of the liquid crystal display device 111 are at the highest position in the Z-axis direction and farthest from the base member 112. However, at both end positions in the Y-axis direction, the input surface 111S1 and the input opposite surface 111S2 are at the lowest position in the Z-axis direction and curved to be closest to the base member 112. Therefore, the space between the input opposite surface 111S2 and the base member 112 is larger on the central side in the X-axis direction and is narrower on the both ends in the X-axis direction.

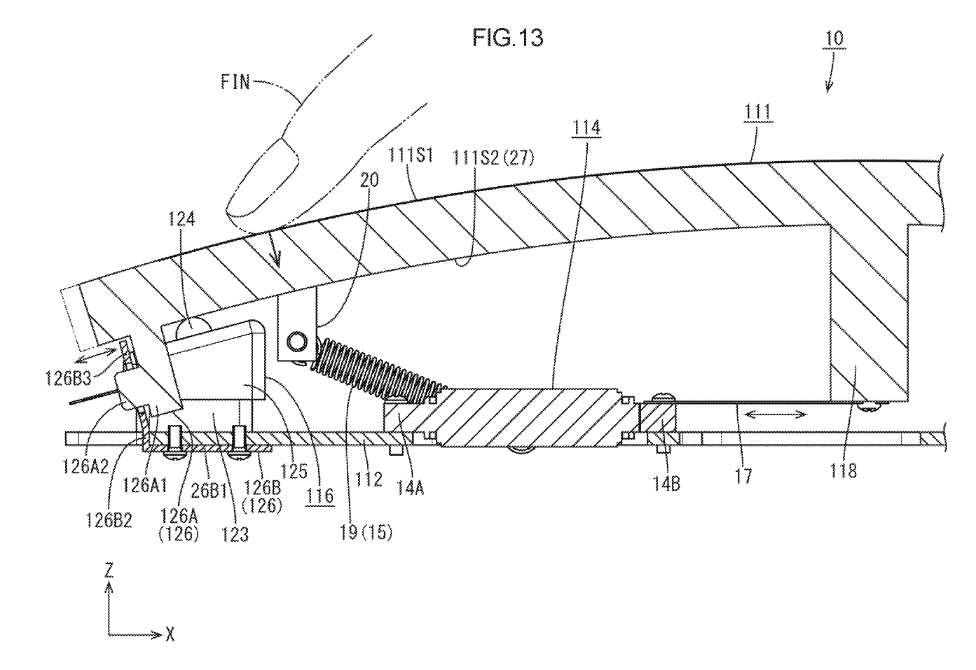

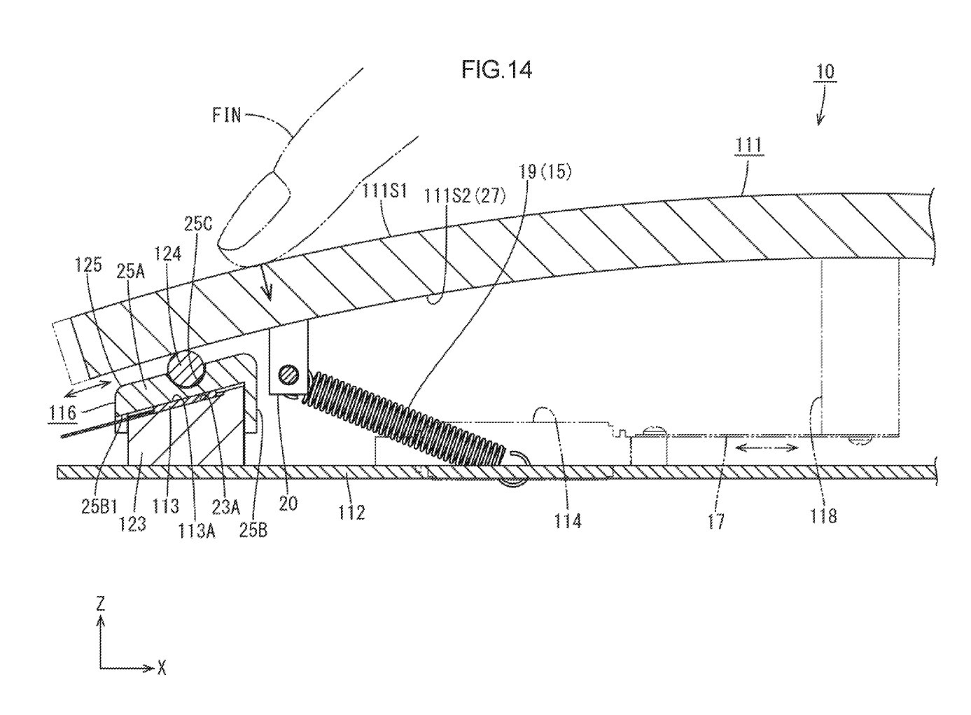

As the curved shape of the liquid crystal display device 111 is changed as above, a pressure sensor unit 116 and a concavo-convex engagement structure 126 have the following structure. First, each front surface of a contact member holder 125 and a sensor holder 123 of the pressure sensor unit 116, and a pressed surface 113A of a pressure sensor 113 are curved parallel to the input opposite surface 111S2 of the liquid crystal display device 111 as illustrated in FIG. 14, and are lower on the central side of the liquid crystal display device 111 and higher on the outside in the X-axis direction. In addition, the drawing direction of a drawn part of the pressure sensor 113 is inverted from that in the first embodiment, and is an outward direction of the liquid crystal display device 111 in the X-axis direction. In addition, a base part 126A1 of a liquid crystal display device-side engagement structure 126A of the concavo-convex engagement structure 126 protrudes along the normal direction to the input opposite surface 111S2 as illustrated in FIG. 13, and is directed to the central side of the liquid crystal display device 111 in the X-axis direction. A protruding direction of an engagement convex part 126A2 is parallel to the input opposite surface 111S2 and obliquely downward as illustrated in FIG. 13. A base part parallel part 126B3 of a base member-side engagement structure 126B of the concavo-convex engagement structure 126 is parallel to the base part 126A1, and is inclined outward with respect to a rising part 126B2. In addition, of a movable side bracket 118 provided at the central position in the X-axis direction of the liquid crystal display device 111, the protruding length from the input opposite surface 111S2 is larger than that described in the first embodiment.

In this structure, the liquid crystal display device 111 that vibrates as the actuator 114 oscillates can be displaced in the direction parallel to the input surface 111S1 by the input opposite surface 111S2 being in contact with the contact member 124 illustrated in FIG. 14 in a manner similar to the first embodiment. Thus, the tactile feedback performance becomes excellent.

### Third Embodiment

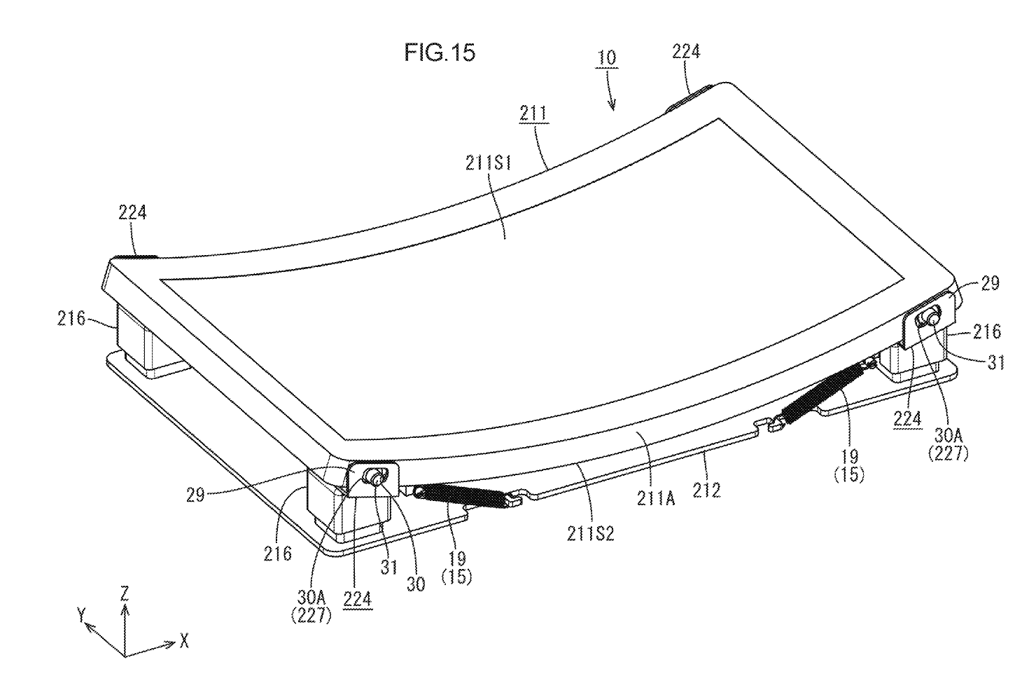

A third embodiment of the technology described herein will be described with reference to FIG. 15 to FIG. 19. In the third embodiment, a structure of a contact member 224 and a guide part 227 is different from that of the first embodiment, and the concavo-convex engagement structure 26 is omitted. Note that description of the structure, the operation, and the effect that are similar to those of the first embodiment is not repeated.

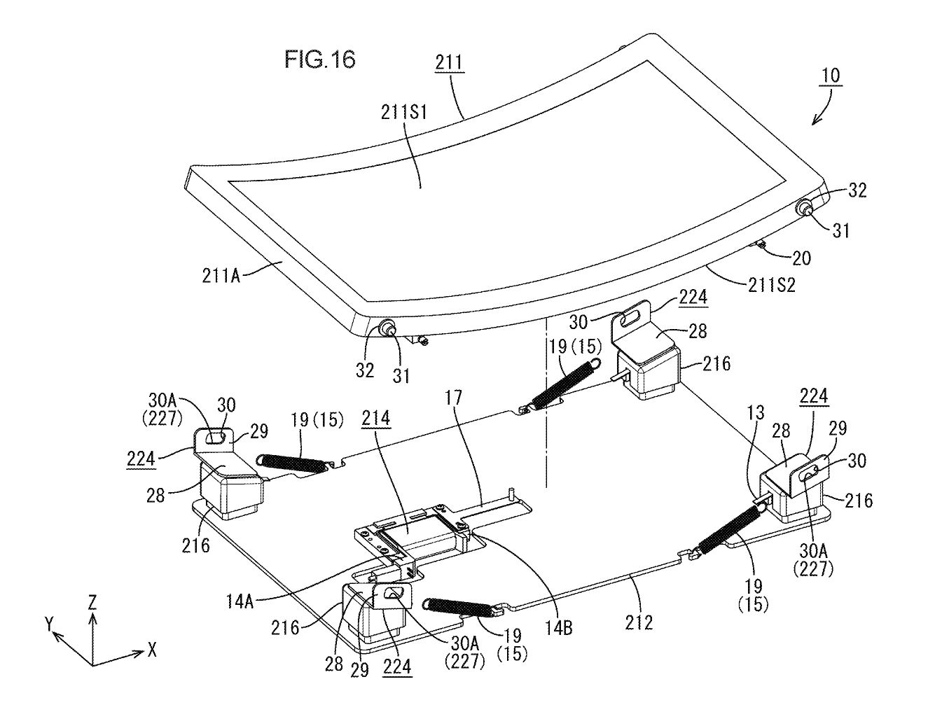

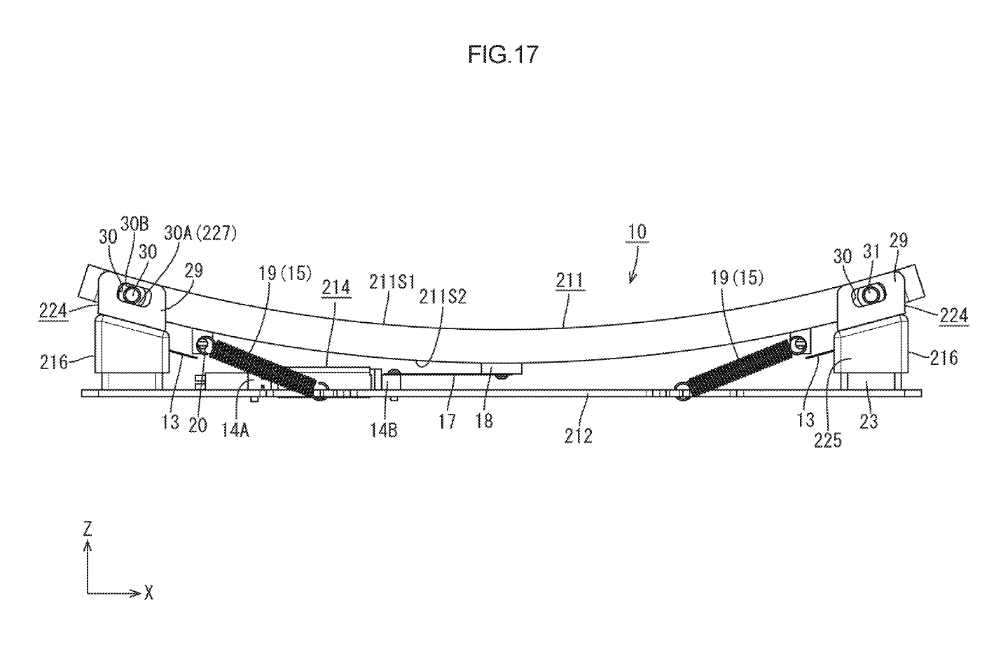

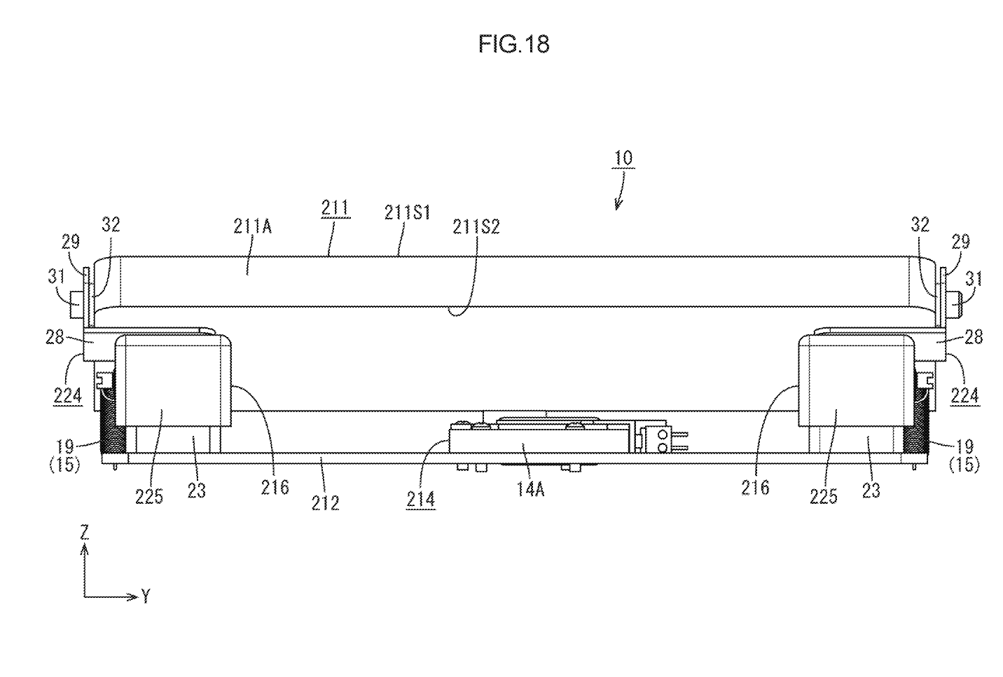

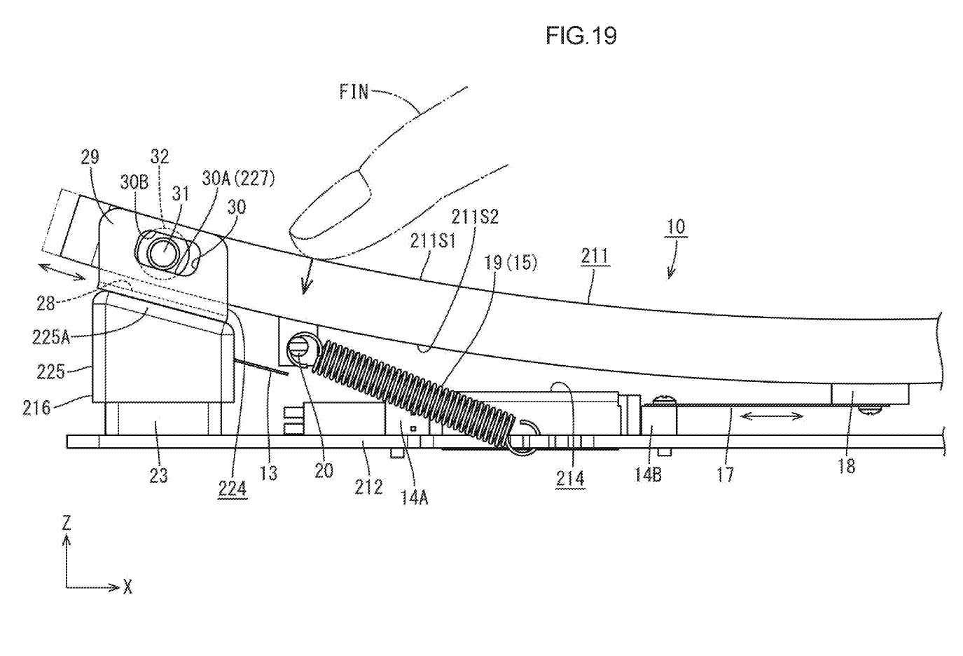

The contact member 224 according to the present embodiment includes a plate material having a substantial L shape as illustrated in FIG. 15 and FIG. 16. Specifically, the contact member 224 includes a holder attachment piece 28 that is attached to a main part 225A of a contact member holder 225 of a pressure sensor unit 216, and a guide piece 29 that rises from an end of the holder attachment piece 28 in the Y-axis direction. Note that the contact member holder 225 does not have the contact member housing concave part 25C described in the first embodiment (see FIG. 7), and the main part 225A has a plate-like shape that is curved parallel to an input opposite surface 211S2 as illustrated in FIG. 19. The holder attachment piece 28 includes a plate surface being parallel to a plate surface of the main part 225A (input opposite surface 211S2) and has a plate-like shape that is curved. The holder attachment piece 28 is disposed with a predetermined space from the input opposite surface 211S2 of a liquid crystal display device 211. The guide piece 29 is disposed with a predetermined external space from and facing an outer surface of a housing 211A of the liquid crystal display device 211 on the long side in the Y-axis direction as illustrated in FIG. 18. Therefore, the liquid crystal display device 211 is disposed between both guide pieces 29 in a pair of contact members 224 included in a pair of pressure sensor units 216 that is arranged with a space therebetween in the Y-axis direction. This guide piece 29 has a guiding concave part 30 that penetrates therethrough as illustrated in FIG. 17. The liquid crystal display device 211 is provided with a guided convex part 31 that is inserted into the guiding concave part 30. The guiding concave part 30 and the guided convex part 31 are hereinafter described in detail.

The guided convex part 31 has a cylindrical shape that protrudes along the Y-axis direction from an outer surface of the housing 211A of the liquid crystal display device 211 in the Y-axis direction as illustrated in FIG. 16. Four guided convex parts 31 are provided in total, and each pair of guided convex parts 31 is provided near the end of the outer surface of the housing 211A in the X-axis direction. As illustrated in FIG. 17 and FIG. 19, the guiding concave part 30 has an oval shape that is curved parallel to an input surface 211S1. The length direction (long-side direction) of the guiding concave part 30 coincides with the curving direction of the input surface 211S1, and the width direction (short-side direction) thereof coincides with the normal direction to the input surface 211S1. As illustrated in FIG. 19, the length and the width (space between a contact surface 30A and a contact opposed surface 30B) of the guiding concave part 30 are both larger than the diameter (outer shape size) of the guided convex part 31, and the length of the guiding concave part 30 is larger than the width thereof. Apart of an inner peripheral surface of the guiding concave part 30 that extends in the length direction and is disposed on the base member 212 side in the Z-axis direction serves as the contact surface 30A that contacts the guided convex part 31, and another part of the inner peripheral surface that is opposite to the base member 212 side is the contact opposed surface 30B that faces the contact surface 30A. The contact surface 30A and the contact opposed surface 30B are curved parallel to the input surface 211S1. In the present embodiment, the contact surface 30A forms the guide part 227 that displaces the liquid crystal display device 211 in the direction along the input surface 211S1 (first direction, curving direction). In addition, the outer surface of the housing 211A of the liquid crystal display device 211 in the Y-axis direction is provided with a partially contacting part 32 that protrudes toward the guide piece 29 of the contact member 224 and partially contacts the guide piece 29 as illustrated in FIG. 16 and FIG. 18. The partially contacting part 32 is formed with a diameter greater than that of the guided convex part 31, is disposed concentrically with the guided convex part 31, and is connected to the guided convex part 31. The protruding length of the partially contacting part 32 from the outer surface of the housing 211A is substantially equal to the space between the outer surface of the housing 211A and the guide piece 29. Thus, the partially contacting part 32 contacts a part of the guide piece 29 (a part of the periphery of the guiding concave part 30).

Next, description will be made of operation and effect of the present embodiment. When the liquid crystal display device 211 that vibrates as an actuator 214 oscillates is displaced outward in the X-axis direction, as illustrated in FIG. 19, the liquid crystal display device 211 is displaced in the direction parallel to the input surface 211S1 (first direction) by the contact surface 30A corresponding to the guide part 227. Specifically, the contact surface 30A of the guiding concave part 30 of the contact member 224 is curved parallel to the input surface 211S1; therefore, a component force parallel to the input surface 211S1 acts on the guided convex part 31 to be in contact with the contact surface 30A by the contact surface 30A, and with this component force, the guided convex part 31 runs on the contact surface 30A, and the liquid crystal display device 211 is displaced in the first direction. Thus, the vibration in a direction parallel to the input surface 211S1 transmits to the finger FIN that has input the pressing operation to the input surface 211S1. Accordingly, the user easily feels as if the user pressed a virtual button in the normal direction to the input surface 211S1 (second direction) on the input surface 211S1 by a lateral force field phenomenon. In addition, while the liquid crystal display device 211 vibrates, the guided convex part 31 slides on the contact surface 30A in the guiding concave part 30; however, the sliding on the contact opposed surface 30B is avoided. Thus, the frictional resistance between the guided convex part 31 and the guiding concave part 30 is reduced, and therefore, the vibration of the liquid crystal display device 211 attenuates less easily; accordingly, the tactile feedback performance is enhanced. In addition, when the pressing operation is performed on the liquid crystal display device 211 by the finger FIN, the liquid crystal display device 211 is allowed to be displaced in the normal direction to the input surface 211S1 by the clearance formed between the guided convex part 31 and the contact opposed surface 30B of the guiding concave part 30. Furthermore, the partially contacting part 32 partially contacts the guide piece 29 of the contact member 224. Therefore, as compared to a case in which the surface of the pair of contact members 224 that faces the liquid crystal display device 211 is entirely in contact with the liquid crystal display device 211, the area in which the partially contacting part 32 contacts the guide piece 29 is smaller. Thus, since the frictional resistance between the liquid crystal display device 211 and the contact member 224 is reduced, the vibration of the liquid crystal display device 211 attenuates less easily. Therefore, the tactile feedback performance is enhanced.

According to this embodiment, the guided convex part 31 included in one of the liquid crystal display device 211 and the contact member 224, and the guiding concave part 30 that is included in the other of the liquid crystal display device 211 and the contact member 224 and receives the guided convex part 31 are provided. The guide part 227 includes the contact surface 30A of the guiding concave part 30 that contacts the guided convex part 31 and extends along the input surface 211S1. Thus, when the liquid crystal display device 211 vibrates as the actuator 214 oscillates, the contact surface 30A of the guiding concave part 30 that extends along the input surface 211S1 and forms the guide part 227 contacts the guided convex part 31; thus, the liquid crystal display device 211 is guided to be displaced in the direction along the input surface 211S1.

The guiding concave part 30 includes the contact opposed surface 30B that faces the contact surface 30A. The contact surface 30A is separated from the contact opposed surface 30B by a space that is greater than a dimension of the guided convex part 31 measuring in a direction in which the contact surface 30A is separated from the contact opposed surface 30B. In this case, while the liquid crystal display device 211 vibrates, the guided convex part 31 slides on the contact surface 30A of the guiding concave part 30, but the sliding on the contact opposed surface 30B is avoided. Thus, since the frictional resistance between the guided convex part 31 and the guiding concave part 30 is reduced, the vibration of the liquid crystal display device 211 attenuates less easily. Therefore, the tactile feedback performance is enhanced. In addition, when the pressing operation is performed on the liquid crystal display device 211 by the finger FIN, the liquid crystal display device 211 is allowed to be displaced in the normal direction to the input surface 211S1 by the clearance formed between the guided convex part 31 and the contact opposed surface 30B of the guiding concave part 30.

Moreover, at least two contact members 224 are provided to hold the liquid crystal display device 211 from sides in the third direction that is perpendicular to the first direction and the second direction. The first direction corresponds to the direction in which the liquid crystal display device 211 is guided by the guide part 227. The second direction corresponds to the normal direction to the input surface 211S1. At least one of the liquid crystal display device 211 and the at least one pair of contact members 224 includes the partially contacting part 32 that protrudes toward the counterpart and partially contacts the counterpart such that the partially contacting part 32 is contiguous to the guided convex part 31. Thus, as compared to a case in which the surface of the at least one pair of contact members 224 that faces the liquid crystal display device 211 is entirely in contact with the liquid crystal display device 211, the area in which the partially contacting part 32 contacts the counterpart is smaller. Thus, since the frictional resistance between the liquid crystal display device 211 and the contact member 224 is reduced, the vibration of the liquid crystal display device 211 attenuates less easily. Therefore, the tactile feedback performance is enhanced. Furthermore, the partially contacting part 32 is provided contiguously to the guided convex part 31; thus, the guided convex part 31 is reinforced.

### Other Embodiments

The technology described herein is not limited to the embodiments described above and with reference to the drawings. The following embodiments may be included in the technical scope.

(1) The above embodiments have described the case in which the liquid crystal display device is curved as a whole. However, the liquid crystal display device may be partially curved. For example, both end parts or one end part of the liquid crystal display device in the long-side direction may be selectively curved, and the rest may be flat. In this case, in the input surface of the liquid crystal display device, the flat part may be parallel to the vibrating direction of the actuator. In another embodiment, a central part, or a central part and one end part of the liquid crystal display device in the long-side direction may be selectively curved, and end parts or the other end part may be flat. In this case, the entire input surface of the liquid crystal display device may be in a relation of intersecting with the vibrating direction of the actuator, or the input surface may be partially in a relation of being parallel to the vibrating direction. Furthermore, the specific shape of the liquid crystal display device can be changed as appropriate.

(2) The above embodiments have described the case in which the liquid crystal display device is curved (in an arc shape) when viewed from a side. However, the liquid crystal display device may be uncurved and be linear when viewed from a side. For example, the liquid crystal display device may be bent to be a V-like shape when viewed from a side. Furthermore, the specific shape of the liquid crystal display device can be changed as appropriate.

(3) In addition to the above (1) and (2), the liquid crystal display device may have a structure in which the entire input surface is flat. In this case, the input surface of the liquid crystal display device is disposed to intersect with the vibrating direction of the actuator.

(4) The above embodiments have described the case in which the contact member is included in the pressure sensor unit. However, the contact member may be provided separately from the pressure sensor unit. In this case, the contact member is not overlapped with the pressure sensor.

(5) The first and second embodiments have described the case in which the contact member is the sphere serving as the rolling element. However, the contact member may be a roller member corresponding to the rolling element. The roller member is preferably configured to be capable of rolling around a roll shaft parallel to the third direction (Y-axis direction). Furthermore, the specific structure of the contact member serving as the rolling element can be changed as appropriate.

(6) The first and second embodiments have described the case in which the input opposite surface is parallel to the input surface and forms the guide part. However, the guide part may be provided separately from the input opposite surface. In this case, the input opposite surface may be non-parallel to the input surface (the input opposite surface may intersect with the input surface). In this case, for example, instead of the sphere serving as the contact member, the contact member including the contact surface being parallel to the input surface may be provided, and this contact surface may serve as the guide part. In addition, in a case in which the input opposite surface is non-parallel to the input surface, the entire input opposite surface may be flat, for example.

(7) The first and second embodiments have described the case in which the liquid crystal display device-side engagement structure of the concavo-convex engagement structure is integrated with the housing of the liquid crystal display device. However, the liquid crystal display device-side engagement structure may be a component separate from the liquid crystal display device, and may be attached to the housing. Alternatively, the base member-side engagement structure may be integrated with the base member.

(8) The first and second embodiments have described the case in which the liquid crystal display device-side engagement structure of the concavo-convex engagement structure includes the engagement convex part and the base member-side engagement structure includes the engagement concave part. However, the liquid crystal display device-side engagement structure may include the engagement concave part, and the base member-side engagement structure may include the engagement convex part.

(9) The third embodiment has described the case in which the guided convex part is in direct contact with the contact surface of the guiding concave part. However, a bearing may be disposed between the guided convex part and the contact surface of the guiding concave part. Since this structure can reduce the friction resistance that could occur between the guided convex part and the contact surface, the tactile feedback performance can be enhanced.

(10) The third embodiment has described the case in which the guiding concave part is provided to penetrate the guide piece of the contact member. However, the guiding concave part may be provided so as to be depressed without penetrating the guide piece.

(11) The third embodiment has described the case in which the guided convex part is included in the liquid crystal display device and the guiding concave part with the contact surface is included in the contact member. However, the guiding concave part with the contact surface may be included in the liquid crystal display device, and the guided convex part may be included in the contact member. In this case, for example, the guiding concave part may be provided by depressing the housing of the liquid crystal display device.

(12) Since the input opposite surface of the liquid crystal display device does not form the guide part in the third embodiment, the input opposite surface may be non-parallel to the input surface. In this case, the entire input opposite surface may be flat.

(13) Although the guiding concave part includes the contact opposed surface in the third embodiment, it is possible that the guiding concave part includes the contact surface but does not include the contact opposed surface. Specifically, for example, the guide piece may be cut such that the guiding concave part is open to the side opposite to the base member-side in the Z-axis direction.

(14) The third embodiment has described the case in which the partially contacting part is included in the liquid crystal display device. However, the partially contacting part may be included in the contact member. Alternatively, the partially contacting part may be included in both the liquid crystal display device and the contact member.

(15) The above embodiments have described the case in which the axial direction of the extension coil spring corresponding to the elastic member is inclined relative to both the X-axis direction and the Z-axis direction. However, the axial direction of the extension coil spring may be inclined relative to both the Y-axis direction and the Z-axis direction. Alternatively, the axial direction of the extension coil spring may be parallel to any one of the X-axis direction, the Y-axis direction, and the Z-axis direction.

(16) The above embodiments have described the case in which the extension coil spring is used as the elastic member. However, another member such as a compression coil spring or a plate spring member maybe used as the elastic member. Among these members, the plate spring member is a spring part that is partially curved or bent, and by using the elastic force generated in this spring part, the liquid crystal display device is elastically supported.

(17) The above embodiments have described the pressure sensor of the pressure sensitive ink type. However, the pressure sensor may be, for example, a piezoelectric element type.

(18) The above embodiments have described the structure including only one actuator. However, the number of actuators may be two or more.

(19) The above embodiments have described the case in which the actuator is an electromagnetic actuator. However, the actuator maybe an inertia driving actuator such as a piezoelectric actuator or a linear actuator. In this case, the inertia driving actuator is not disposed on the base member-side but disposed only on the liquid crystal display device-side.

(20) The above embodiments have described the in-cell type in which the touch panel pattern is incorporated in the liquid crystal panel. However, an out-cell type may alternatively be employed in which the touch panel pattern is provided on the front side of the liquid crystal panel.

(21) The above embodiments have described the case in which the touch panel pattern is a self-capacitance type. However, the touch panel pattern may be a mutual capacitance type. In addition, the planar shape of the touch electrode of the touch panel pattern may be a rhomboidal shape, a square shape, a circular shape, a polygonal shape of a pentagonal shape or more, or the like.

(22) The above embodiments have described the case of using the liquid crystal display device including the touch panel pattern. However, the liquid crystal display device without the touch panel pattern may be used.

(23) The above embodiments have described the case in which the planar shape of the input device (liquid crystal display device or base member) is horizontal rectangle. However, the planar shape of the input device may be a vertically rectangular shape, a regular-square shape, an oval shape, an elliptical shape, a circular shape, a trapezoidal shape, or a shape partially having a curved surface, or the like.

(24) The specific purposes of the input device may be changed as appropriate in addition to those described in the above embodiments.

(25) The above embodiments have described the case of using the liquid crystal display device including the liquid crystal panel. However, a display device including another kind of display panel (plasma display panel (PDP), organic EL panel, electrophoretic display panel (EPD), or micro electro mechanical systems (MEMS) display) can also be used.

1. An input device comprising:
an actuator configured to oscillate;
an input member configured to vibrate as the actuator oscillates, the input member including an input surface receiving pressing operation, and at least apart being disposed to intersect with a vibrating direction in which the input member vibrates as the actuator oscillates;
at least one contact member contacting the input member; and
a guide part included in at least one of the input member and the at least one contact member and configured to guide the input member in a direction parallel to the input surface during vibration of the input member.

2. The input device according to claim 1, further comprising a pressure sensor configured to detect a pressure acting on the input member along with the pressing operation.

3. The input device according to claim 2, wherein the pressure sensor is disposed such that at least a part of the at least one contact member is disposed between the pressure sensor and the input member.

4. The input device according to claim 2, wherein
the pressure sensor includes a pressed surface configured to receive the pressure, and
the pressed surface is disposed parallel to the input surface.

5. The input device according to claim 2, further comprising:
a base member including at least the at least one contact member; and
an elastic member attached to the input member and the base member, is the elastic member being elastically deformable in the direction in which the input member is guided by the guide part and in a normal direction to the input surface.

6. The input device according to claim 5, wherein the elastic member includes an extension coil spring including a first end attached to the input member and a second end attached to the base member.

7. The input device according to claim 1, wherein
the input member includes an input opposite surface disposed opposite to and parallel to the input surface,
the input opposite surface is a section of the guide part, and
the at least one contact member includes a rolling element that contacts the input opposite surface to be rollable.

8. The input device according to claim 7, wherein the rolling element has a sphere shape.

9. The input device according to claim 7, further comprising:
a base member including at least the at least one contact member; and
a concavo-convex engagement structure including a portion of the input member and a portion of the base member that concavo-convexly engage with each other, wherein the concavo-convex engagement structure is configured to allow shift of the input member relative to the base member in a first direction corresponding to the direction in which the input member is guided by the guide part and a second direction corresponding to a normal direction to the input surface and to restrict the shift of the input member relative to the base member in a third direction that is perpendicular to the first direction and the second direction.

10. The input device according to claim 1, further comprising:
a guided convex part included in the input member; and
a guiding concave part included in the at least one contact member in which the guided convex part is disposed,
wherein the guide part includes a contact surface of the guiding concave part that contacts the guided convex part and extends along the input surface.

11. The input device according to claim 10, wherein
the guiding concave part includes a contact opposed surface that faces the contact surface, and
the contact surface is separated from the contact opposed surface by a space that is greater than a dimension of the guided convex part measuring in a direction in which the contact surface is separated from the contact opposed surface.

12. The input device according to claim 10, wherein
the at least one contact member includes at least two contact members to hold the input member from sides with respect to a third direction that is perpendicular to a first direction corresponding to the direction in which the input member is guided by the guide part and a second direction corresponding to a normal direction to the input surface,
the input member includes a partially contacting part that protrudes toward at least one of the at least two contact members to partially contact the at least one of the at least two contact parts, and
the partially contacting part is coupled to the guided convex part.

13. The input device according to claim 1, wherein
the input member has a planar shape that is square,
the at least one contact member includes contact members disposed at corners of the input member, respectively, and
the actuator is disposed inner of the input member relative to the contact member.

14. The input device according to claim 1, wherein the input member includes a display panel including a display surface on which an image is displayed and configured as the input surface, and a touch panel pattern to detect an input position on the display surface at which the pressing operation is received.

15. The input device according to claim 1, further comprising:
a guided convex part included in the contact member; and
a guiding concave part included in the input member in which the guided convex part is disposed,
wherein the guide part includes a contact surface of the guiding concave part that contacts the guided convex part and extends along the input surface.

16. The input device according to claim 15, wherein
the at least one contact member includes at least two contact members to hold the input member from sides with respect to a third direction that is perpendicular to a first direction corresponding to the direction in which the input member is guided by the guide part and a second direction corresponding to a normal direction to the input surface,
at least one of the at least two contact members includes a partially contacting part that protrudes toward the input member to partially contact the input member, and
the partially contacting part is coupled to the guided convex part.
